(19) United States
(12) Patent Application Publication
(10) Pub. No.: US 2025/0206487 A1
(43) Pub. Date: Jun. 26, 2025

(54) SYSTEM AND METHOD FOR LABELLING ROD BUNDLES OR THE LIKE

(71) Applicant: GREEN PROJECT S.R.L., GENOVA (IT)

(72) Inventors: MARCO PODESTA, GENOVA (IT); VALERIO TUMINO, GENOVA (IT)

(73) Assignee: GREEN PROJECT S.R.L., GENOVA, GE (IT)

(21) Appl. No.: 18/852,308

(22) PCT Filed: Mar. 28, 2023
(86) PCT No.: PCT/IB2023/053060

§ 371 Date: Sep. 27, 2024

(30) Foreign Application Priority Data
Mar. 29, 2022 (IT) 102022000006104

(51) Int. Cl. B65C 7/00

(52) U.S. Cl. CPC B65C 7/00

(57) ABSTRACT

Labelling system of bundles (300) of rods or bundles of bars, which bundles (300) comprise one or more straps (302) arranged around the bundle (300).

Said system comprises a robotic arm (1), an application head (2) of the label and at least one spool (3) of metal wire, which robotic arm (1) is configured for the movement of said application head (2).

Means are also present for activating the rotation of the spool (3), configured to convey the metal wire inside the application head (2).

The application head (2) comprises wire processing means, automated object recognition means, and means for gripping/releasing (23) at least one label (4), the processing means being configured to unwind the wire and fix a first end of the wire to a strap (302) of the bundle (300) and to engage a second end of the wire to said label (4).

Furthermore, the automated object recognition means comprising identification means of the bundle (300), configured to detect a first section, corresponding to the distance between a strap (302) and an end of the bundle, the wire processing means being configured to execute a cutting of the wire such that the distance between the first end and the second end is greater than said first section.

The present invention relates to a system for labelling rod bundles, bar bundles, or the like, which bundles comprise one or more straps arranged around the bundle.

The system comprises a robotic arm, a label application head and at least one spool of metal wire.

The robotic arm is configured for the movement of the application head.

Means are also present for activating the rotation of the spool, configured to convey the metal wire inside the application head.

The present invention relates in particular to systems used for marking products in steel plants, such as casting and subsequent rolling products.

For example, such products can consist of bars or rebars, profiles or the like, which are grouped together, so as to form bundles of products which are all the same, which are constrained through the use of tapes, straps or the like.

Generally, iron wires with a diameter from 6 to 12 mm or straps with 32 mm×1.2 mm section are used.

The bundles of products which are all the same must be marked through the use of labels which bear information on the products, so that the production chain and the features of the products can be easily identified, functional to the subsequent processes which must be performed.

In the labelling systems known in the state of the art, automated means have been made both for generating the labels and for reading the labels themselves.

It follows that in the state of the art there are known devices which automatically print the information of the products to be marked on the labels, as well as devices capable of automatically reading the information so as to indicate to the operator the subsequent operations that can be carried out on the bundle, as well as the origin of the bundle and the possible path which the bundle must follow inside the steel plant.

In the systems known in the art, however, the automation of the central part of the process is lacking, in particular related to positioning the label on the bundle.

The automatic application systems present to date fix the label to the bundle by means of a direct welding process of a rivet, nail or the like on the head of one of the bars, and the label is supported by means of the rivet itself.

Systems have been developed which use devices in the field of computer vision capable of recognizing objects and which use mechanized robotic arms for positioning and fixing labels to product bundles.

However, such systems are mainly applied to the rod, in which metal rebars are bent so as to follow circular paths and so as to form circles which can be superimposed on each other and held together through cables, wires or straps, so as to form tubular elements.

The automated labelling systems known in the state of the art identify the strap and position the label at the strap, inside the tubular element.

It is clear that such systems cannot be used with regard to the bundles of metal bars, since the labels, placed at the straps which fix the bars therebetween, would risk remaining hidden in the event that, as usually occurs, different bundles of bars are stacked on top of each other.

Therefore, the overlapping of the different bundles does not allow the labels to be read in an automated manner, making the work of the operator complex, who will not be able to quickly and effectively know the subsequent processing and destinations of the bundle of bars and entails the risk of loss of the label itself due to the overlapping.

For this reason, especially in the case of bundles of bars, the positioning of the labels is performed manually by an operator, who generally fixes the label to the strap with a metal wire.

The operator must ensure that a length of the metal wire is used, such that the label can exit from the bundle, once a further bundle is overlapped.

The manual procedure obviously has disadvantages from the point of view of the timing of conduct, since a bundle of bars is produced about every 60-90 seconds, on which the straps are placed, but the operator is not always able to position the label and check that the length of the wire used is of the correct size, before a subsequent bundle is stacked on the bundle currently being processed.

Furthermore, the manual procedure has obvious disadvantages from the point of view of operator safety, who is found manually acting on moving bundles of bars, putting his safety at risk.

There is therefore a need unsatisfied by the systems known in the state of the art to solve the disadvantages set forth above, in particular the need to make a fully automated labelling system, adaptable to any product bundle, in a fast and safe manner for the operator.

The present invention achieves the above objects by making a system as described above, in which the application head comprises wire processing means, automated object recognition means, and means for gripping/releasing at least one label and avoiding welding to a rivet bar.

In particular, the processing means are configured to unwind the wire and fix a first end of the wire to a strap of the bundle and to engage a second end of the wire to the label.

Furthermore, the automated object recognition means comprise bundle identification means, configured to detect a first section, corresponding to the distance between a band and an end of the bundle, the wire processing means being configured to execute a cutting of the wire such that the distance between the first end and the second end of the wire is greater than the first section.

By virtue of such a configuration, a fully automated procedure is obtained, in which the ends of the wire are automatically fixed, respectively, to the strap and to the label, ensuring that the label is always placed outside the bundle of products.

In fact, as will be evident from the illustration of some embodiments, the calculation of the distance between the end of the bundle and the strap allows to perform a cutting of the metal wire which is sufficient to ensure the correct positioning of the label.

The presence of the robotic arm and object recognition means represents a peculiar aspect of the present invention, in that it allows to make a metal wire to which to fix a label and which is in turn fixed to a bundle of metal bars through a manipulator.

Therefore, unlike the systems known in the state of the art, the metal wire is formed and then subsequently fixed to a bundle of bars: the length of the wire is decided based on information related to the bundle of metal bars which is written on the label, information obtained by virtue of the object recognition means, capable of calculating the distance between one end of the bundle and the strap.

Unlike the systems known in the state of the art, the present invention allows to form the metal wire directly on the bar to be labelled, no prior information is necessary, the system works automatically, adapting the formation of the wire based on the type of bars and binding which it must label.

The advantages are not only related to a greater adaptability of the system described by the present invention, but also relate to an improvement of the fixing of the wire itself, since the end eyelet is formed directly on the strap of the bundle of bars, stably fixing the wire to the strap itself.

Some systems known in the state of the art instead envisage the formation of open end eyelets, which not only are fixed less stably, but are also more complex to couple to the straps of the bars.

The mechanical features of the metal wire, in particular the rigidity thereof, avoid the risk that the label ends up in the middle of two bundles of overlapping products.

The ends of the wire can be fixed to the strap and to the label in any of the manners known in the prior art.

For example, the application head can be provided with means for welding the wire to the strap and/or to the label.

Preferably, according to a preferred embodiment, the first end is fixed to the strap through an annular element, i.e., the wire is processed so as to form an annular element which surrounds the strap, advantageously through a bending thereof.

In combination with such a feature, it is possible to envisage that the second end of the wire, once cut, is also folded so as to form an annular element, which prevents the label from being removed, through the second end, from the wire.

The annular element of the second end therefore constitutes a kind of stop of the label.

The creation of the annular elements allows to obtain a firm fixing, at least of the first end to the strap of the bundle, even in the event of unexpected tensions acting on the label, or of any crushing caused by the overlapping of one or more bundles of products.

It is possible to envisage that the metal wire is folded at the second end so as to form an annular element which is inserted, at least partially, inside a corresponding hole provided on the label.

According to a preferred embodiment, the processing means comprise an inlet wire guide element, a wire cutting device, a first wire bending device, label gripping/releasing means, an outlet wire guide element and a second wire bending device.

Such components can be provided in any order, however, they are provided in the order just described, by the robotic arm in the direction of the application head, i.e., in the direction of the bundle of products to be processed.

Advantageously, as will be apparent from the illustration of some embodiments, the wire guide elements consist of tubular elements having a funnel mouth.

In fact, the wire guide elements have wire drawing means, which, in combination with the wire bending devices, can cause undesired rotations of the wire about their longitudinal axis.

For this reason, the funnel shape facilitates the insertion of the free end of the wire into the wire guide elements.

In addition to the funnel shape, in order to avoid stresses on the metal wire created by the aforesaid rotations, a straightening device configured to straighten the wire can be provided.

Advantageously, said straightening device is interposed between the inlet wire guide and dragging device and the outlet wire guide device

According to an embodiment, the gripping/releasing means are configured to block the label so that the label has the hole in line with the inlet wire guide element.

All the wire processing means, as will be described later, work “in line” i.e., the wire is dragged according to a linear direction, so that it can be easily inserted inside the hole of the label and can be even more easily bent for the creation of the annular elements at the ends.

The system object of the present invention can include the operation monitoring systems known in the prior art, for example systems for reporting malfunctions of the robotic arm, of the application head or of the components of the application head.

Advantageously, between these systems it is possible to provide a spool sensor, aimed at detecting the amount of wire present at the spool.

Such a sensor can therefore alert the operator in the event that the wire is missing, requesting the subsequent replacement thereof.

As anticipated, the wire processing means envisage executing machining on the wire so as to make a wire with the ends fixed, respectively, to the strap and to the label, so as to correctly label the product bundle.

Once the processing on the wire has been completed, the latter must be expelled from the application head, for this reason the application head includes wire retention means, which retention means pass from a wire retention condition to a wire release condition, in which the wire is free to exit the application head.

As will be described below, according to a preferred embodiment, said retention means consist of a movement of the bending devices of the wire and of the wire guide elements.

According to a further embodiment, the second bending device comprises at least three castors rotatably mounted and arranged on a plane so as to identify a space inside which to pass the wire.

Furthermore, at least one castor is translatably mounted along said plane.

The possibility of translating the castor allows to increase/decrease the diameter of the annular element forming the first end, so as to give the system object of the present invention a high adaptability based on the different straps used in the product bundles.

According to a further embodiment, the wire spool is positioned on the label application head.

Such a positioning is not one of the possible constructive choices, but has specific advantages.

In fact, such a positioning allows to reduce the path of the wire itself to reach the outlet of the application head and, therefore, makes the path of the wire more regular and less subject to bending and consequently more stable.

From what has just been described, it is evident that the system object of the present invention, in addition to the advantages described above, allows to make a particularly compact system, since practically all the devices are on board the robotic arm and the application head. Such a feature results in high ease of use and easier maintenance.

In view of the advantageous features of the system just described, the present invention also relates to a labelling method of rod bundles or bar bundles.

The method preferably includes the use of the labelling system described above.

Furthermore, the method object of the present invention includes the following steps:
identifying the bundle,
positioning the application head at the bundle,
identifying a strap,
calculating the distance between the strap and one end of the bundle,
positioning the application head at the bundle,
unwinding the wire,
fixing a first end of the wire to a strap,
unwinding the wire,
cutting the wire so that the length between the two ends is greater than the distance between the strap and the end of the bundle,
fixing the label to the second end,
releasing the cut wire from the application head.

That which was just described is the methodology related to processing the wire, which is combined with the action of the label gripping/releasing means, which as will be described later, pick up the label from a special printer, maintain it so as to allow the fixing of the wire and release it, once the wire has been correctly processed.

The method object of the present invention allows to obtain a particularly fast execution of the labelling of the bundle.

As anticipated, the following steps of the cycle can be defined:
printing and picking up the label and positioning the robot in standby: to be executed in the shadow of the bundle transfer and positioning. Moreover, such functions require an approximate time of 10 seconds,
searching for the coupling position, about 5-8 seconds,
coupling, development of cutting wire and label fixing, 10 seconds,
return to standby position, 3 seconds.

The total time of the entire labelling process, per single bundle, is about 20 seconds.

According to a preferred embodiment, a step of identifying a fixing seat of the first end of the wire is provided.

In fact, the automated object recognition means allow to evaluate whether under there is the necessary space for passing the wire under the strap, bent so as to create the annular element described hereinbefore.

Preferably, in fact, the fixing seat must have a minimum section of about 10×5 millimetres. If such a passage section is not present, the bundle cannot be labelled, therefore it will be necessary to use a different fixing system of the end of the wire, such as head welding.

These and further objects of the present invention are achieved by a labelling system and method according to the appended independent claims and the sub-claims.

Optional features of the device of the invention are contained in the attached dependent claims, which form an integral part of the present disclosure.

These and other features and advantages of the present invention will become clearer from the following disclosure of some embodiment examples illustrated in the accompanying drawings in which:

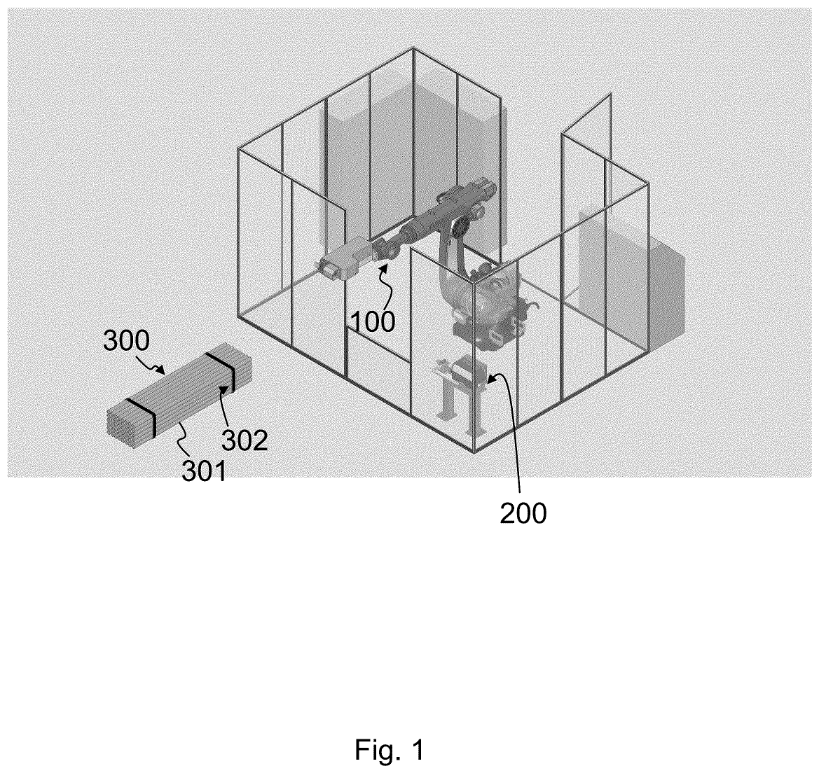

FIG. 1 illustrates a perspective view of the system object of the present invention, in which the system is provided in combination with a bundle of bars and a label printer;

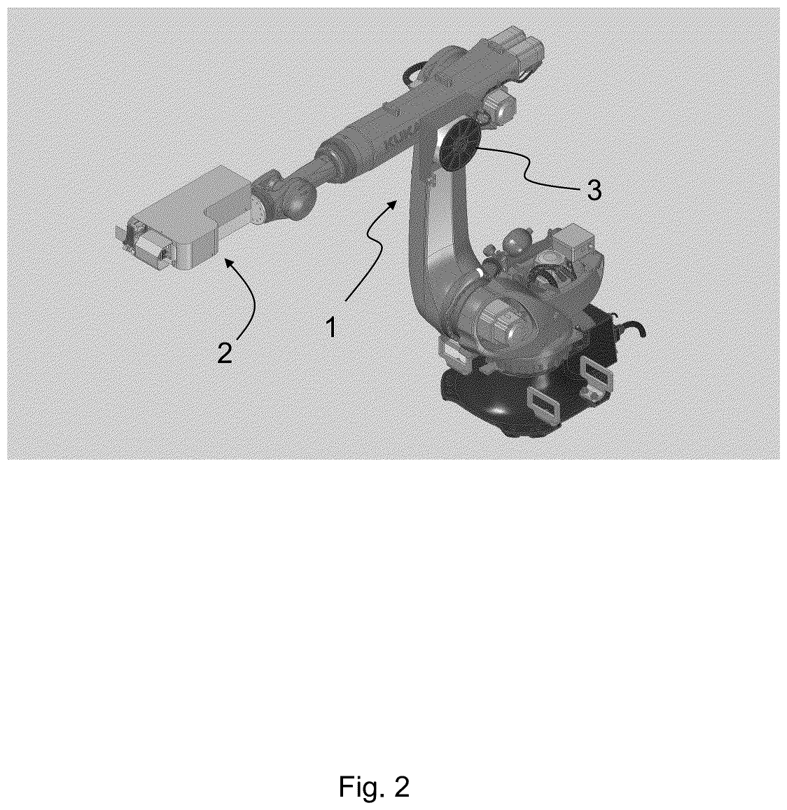

FIG. 2 illustrates a perspective view of the system object of the present invention, according to a possible embodiment;

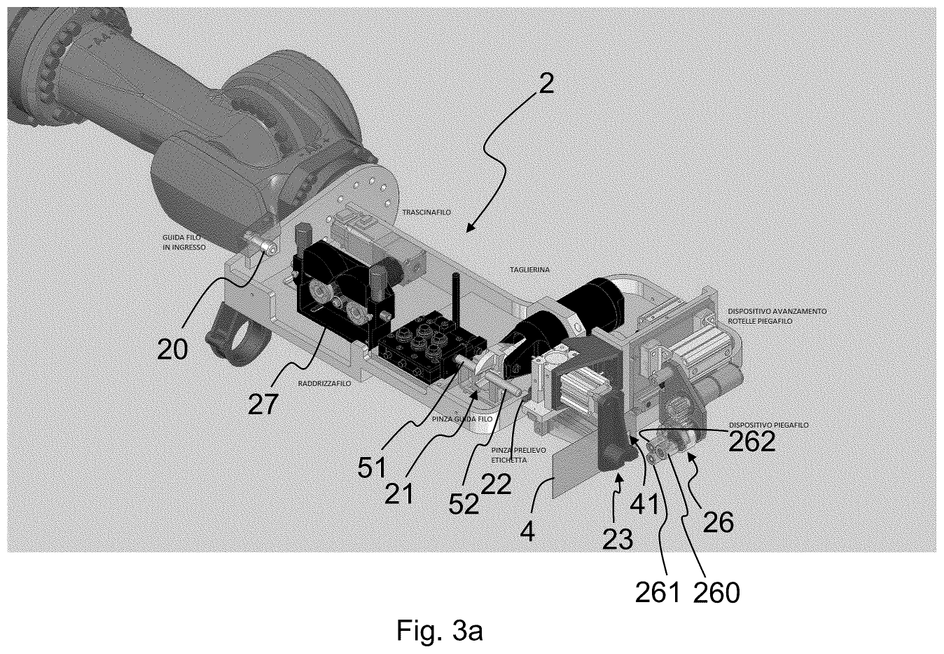

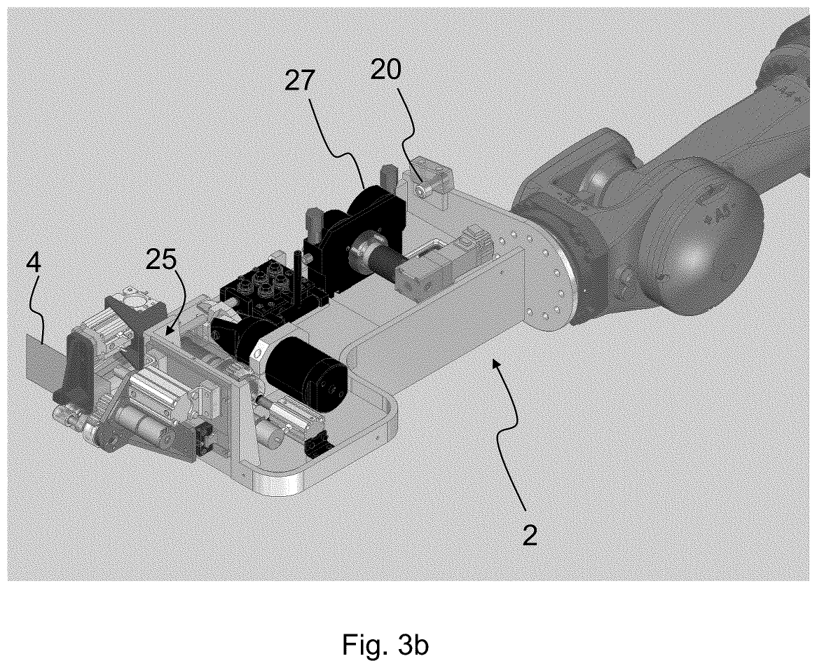

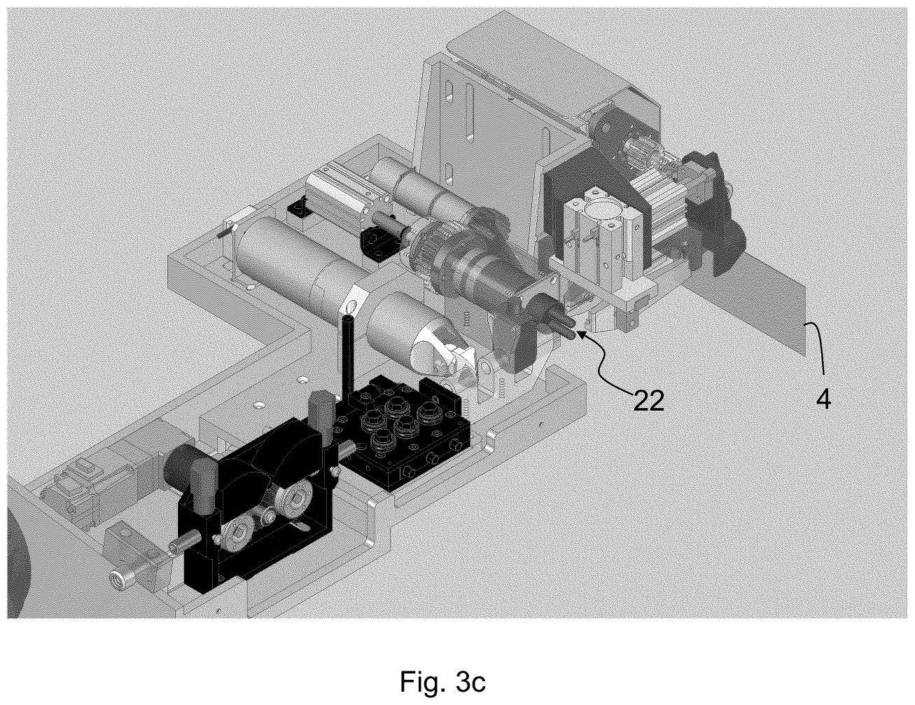

FIGS. 3a to 3c illustrate three detailed views of the application head belonging to the system object of the present invention;

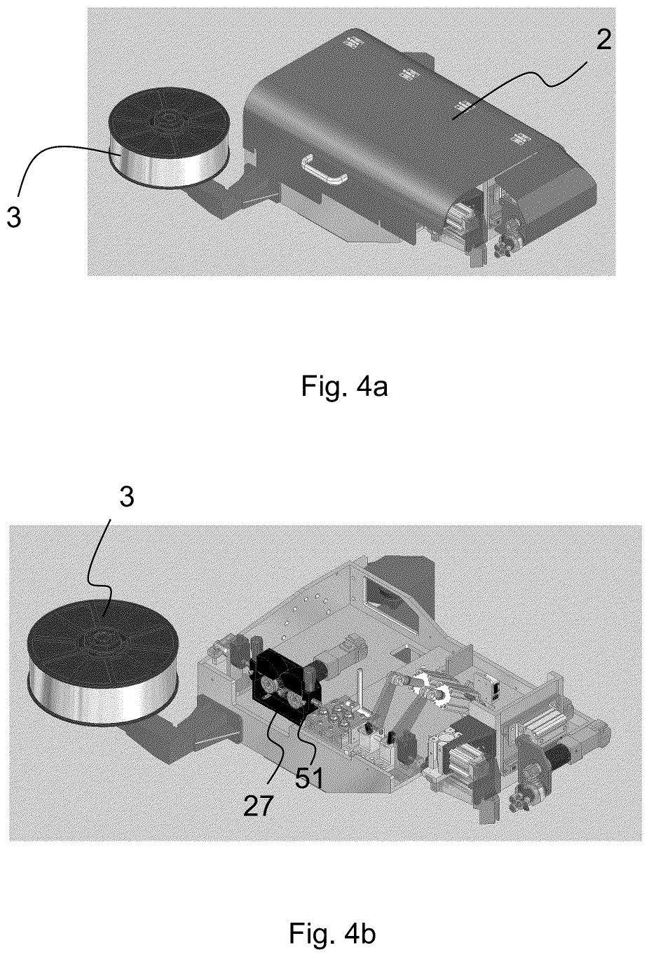

FIGS. 4a and 4b illustrate two views of a detail of the system object of the present invention, according to a possible embodiment;

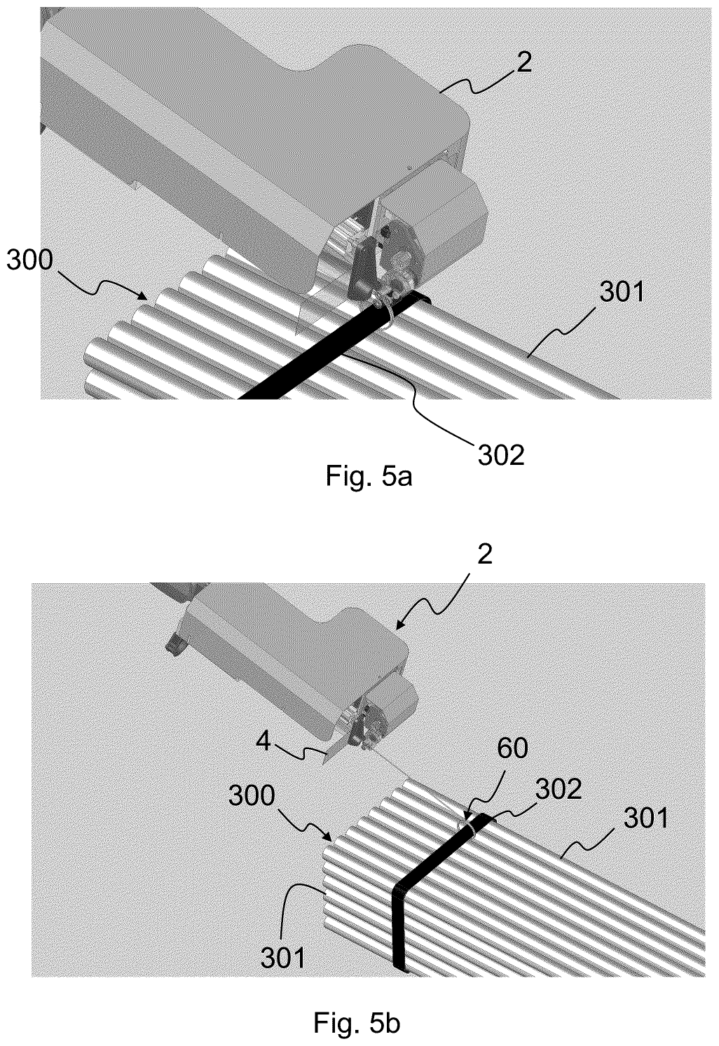

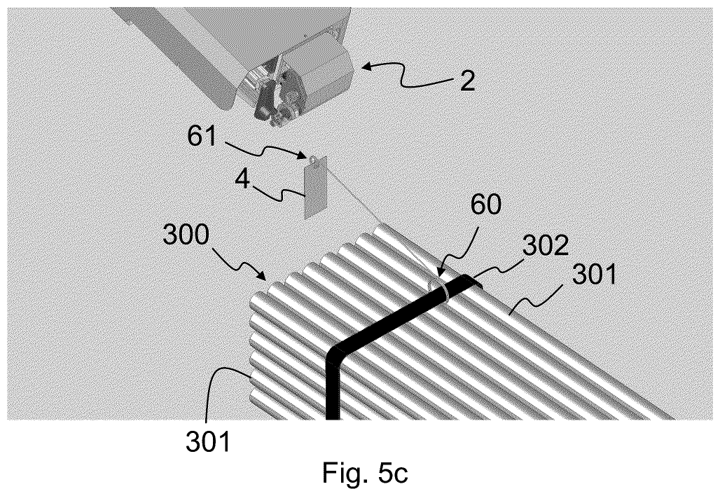

FIGS. 5a and 5c illustrate, through a concept diagram, the steps of the labelling method object of the present invention.

It should be specified that the figures attached to the present patent application illustrate only some possible embodiments of the system and method object of the present invention to better understand its described advantages and features.

Such embodiments are therefore to be intended for purely illustrative and non-limiting purpose of the inventive concept of the present invention, i.e., that of making a completely automated labelling system, adaptable to any product bundle, in a rapid and safe manner for the operator.

With particular reference to FIG. 1, the labelling system 100 object of the present invention is illustrated, positioned inside a possible working environment, comprising a label printer 200 and a bundle of bars 300.

The bundle 300 consists of a plurality of bars 301, grouped into a single bundle through the use of one or more straps 302.

The product to be marked with labels is a bundle of bars 300 of homogeneous shape and size, variable.

In fact, the system object of the present invention can operate on any type of bars 300, arranged according to any geometry.

Generally, the bundle 300 comprises bars of length comprised between 6 and 12 metres and with a diameter between 8 and 100 millimetres.

The position of the bundle 300 is generally horizontal on a working plane, stopped with axis parallel or perpendicular to the robotic arm belonging to the system 100 object of the present invention.

The bundle 300 usually has a strap 302, at a short distance, 300-400 millimetres from the head of the bundle 300. Such a distance is relatively constant and it is preferable to define a positioning tolerance.

Therefore, the system object of the present invention interfaces with the movement line of the bundles 300 which positions them at the system 100 itself.

Positioning members of the bundle 300, known in the state of the art, will therefore be provided, both electric and pneumatic, controlled by a control unit on board the robot.

With particular reference to FIG. 1, a label printer 200 is further included.

The label is preferably printed by means of a thermal printer, or by means of a laser printer or embossing printer and is ejected onto a special plane by the printer itself, so that the application head can pick it up in a simple manner.

In particular, the label ejection and pick-up station must be developed to ensure a certain position of the label in the pick-up step, ensuring the correct passage of the wire inside the label and will be functional to the type of printer chosen.

Preferably, therefore, the printer 200 will be provided with an ejection device, a label blocking device, regulated by a sensor aimed at detecting the presence of the label and possible label support box movement means for the picking up by the robot.

FIG. 2 shows a perspective view of the labelling system 100 object of the present invention, comprising a robotic arm 1, a label application head 2 and at least one metal wire spool 3.

The robotic arm 1 is configured for the movement of the application head 2, in particular it is an anthropomorphic robot known in the state of the art, with six axes, with a minimum capacity of 70-90 kg and reach, as a function of the lay out position of the equipment and the bundle, with a minimum expected reach of 2 metres.

The robotic arm 1, in addition to moving the application head 2, supports the same and provides all the means for adjusting the operation of the various components of the application head 2, which will be described later.

Such adjustment means are mainly electronic and pneumatic means and their activation ensures the correct operation of the different components of the application head 2, according to the modes known in the state of the art.

An inlet/outlet interface will also be present so as to allow an operator to interact with the labelling system 100.

The inlet/outlet interface is also configured to allow the system 100 to communicate with both the manufacturing chain of the bundle 300 and with the printer 200.

The processing times are thereby optimized, as the system 100 will be capable of knowing the times in which to pick up the label from the printer 200 and be able to fix it to the bundle 300.

Among the various operation adjustment means, there are also means for activating the rotation of the spool 3, configured to convey the metal wire inside the application head 2, so that the wire can be processed, to execute the labelling operations, which will be described below.

According to a possible implementation variant, the metal wire is arranged in coils of about 15 kg and is installed on the machine near the “elbow” on the forearm section of the robotic arm 1 so as to reduce the section of wire between the spool 3 itself and the application head.

Before being conveyed inside the application head 2, the metal wire is dragged inside a wire guide placed in a metal protection duct.

As anticipated, a sensor can be included which is capable of identifying the approach of the end of the wire.

Such a sensor can be obtained by means of FTC laser or magnetic sensor.

Advantageously, the application head 2 comprises wire processing means, automated object recognition means, and means for gripping/releasing at least one label.

The processing means are configured to unwind the wire and fix a first end of the wire to a band 302 of the bundle 300 and to engage a second end of the wire to the label.

Automated object recognition means are not illustrated in the figures, but are made according to any of any of the modes known in the prior art.

For example, they can consist of computer vision means, i.e., comprising an acquisition unit, of the camera type or the like, and a processing unit of the images acquired by the acquisition unit, so as to identify known objects, such as the bundle 300 and the strap 302.

With reference to FIG. 2, the automated recognition means will, for example, be placed below the application head 2, so as to better frame the label to be picked up from the printer and the bundle 300.

As will be described later, the automated object recognition means recognize the label, so that the application head 2 can approach it and pick it up through the gripping/releasing means, integrated in the application head 2.

Furthermore, the automated object recognition means are configured to detect a first section, corresponding to the distance between the strap 302 and an end of the bundle 300.

Furthermore, the wire processing means are configured to execute a cutting of the wire whereby the distance between the first end and the second end of the wire is greater than said first section.

From what will be described below, it will be clear how the application head 2, in combination with the robotic arm 1, allow the label to be picked up in an adequate manner to allow the passage of the wire inside a hole of the label.

To facilitate this operation, it is preferable that the label is provided with a hole of minimum size of 8-10 millimetres.

Furthermore, the application head 2 will find the bundle 300 and identify the best position to fix the first end of the wire, checking the distance between the strap 302 and the head 300.

Furthermore, the wire processing means which will be described below according to the embodiment variant illustrated in FIGS. 3a to 3c, bend the wire so as to obtain two “ring” ends, which are fixed to the strap 302 and to the label.

FIGS. 3a to 3c illustrate some details of the application head, so as to describe the processes which are executed on the wire.

According to the variant illustrated in the figures, the processing means comprise an inlet wire guide element 20, a wire cutting device 21, a first wire bending device 22, the gripping/releasing means 23 of the label 4, an outlet wire guide element 25 and a second wire bending device 26.

The inlet wire is dragged along the entire length of the application head 2 through special dragging members 27, consisting for example of gears, as illustrated in FIG. 3a.

The gripping/releasing means of the label can consist of two jaws which clamp the label 4 and block it so that the hole 41 is in line with the path of the metal wire, so as to facilitate the insertion of the metal wire inside the label 4 itself.

It is possible to envisage that the jaws of the gripping/releasing means 23 include end-stroke elements, so that in the event of using labels 4 with constant dimensions, the edges of the label 4 abut such end-stroke elements, always ensuring a correct positioning of the label 4.

Regardless of the configuration of the gripping/releasing means 23, the metal wire is dragged by the dragging members 27 so as to be unwound from the spool 3 and conveyed inside the application head 2 through the inlet wire guide element 20.

Once inserted into the wire guide element 20, the wire is dragged and slides along the cutting device 21 and the first bending device 22, which in this step are not yet activated.

Subsequently, the free end of the wire, i.e., the first end, is inserted inside the hole 41 of the label 4, to reach the outlet wire guide element 25.

At this point, the wire undergoes the first processing, i.e., it is bent by the second bending device 26.

In particular, the second bending device 26 has three castors 260, 261, 262 arranged on a single plane, according to the vertices of a triangle, so as to identify a space within which to pass the second end of the wire.

The castors 260, 261 and 262 are preferably idle, and their peculiar positioning allows, in combination with the thrust generated by the dragging members 27, to bend the wire so as to obtain an annular element, which will be fixed, as illustrated below, to the strap 302 of the bundle 300.

The annular element is formed by virtue of the overlapping of a plurality of circles which are formed following the bending of the wire.

As anticipated, at least one of the castors 260, 261, 262 is provided translatable along the plane on which they are arranged, so as to vary the radius of curvature of the wire.

Once the annular element is generated and fixed to the strap 302 and once the application head is aware of the distance between the strap 302 and the head of the bundle 300, the application head 2 backs up and reverses the direction of the dragging members 27, so that the same unwind a quantity of wire having a length greater than the distance between the strap 302 and the head of the bundle 300.

The measurement of the amount of wire can be performed in any manner known in the state of the art, such as sensors on the spool 3 aimed at detecting the rotation of the spool 3 itself or control of the unwinding motor.

As soon as the necessary quantity of wire is unwound, the cutting device 21 is activated.

For the sake of simplicity and illustration, the wire in FIG. 3a is illustrated only through two portions 51 and 52, one downstream and one upstream of the cutting device 21.

The cutting device 21 preferably consists of a pneumatic cutter whose two parts, approaching each other, cause the cutting of the wire in the portions 51 and 52.

According to a possible embodiment, it is possible to provide a sensor aimed at detecting the condition of the cutting device 21, i.e., the opening/closing condition of the cutter.

When the cutting has occurred, the first bending device 22 is activated, which bends the end of the wire just cut by the cutting device 21, for the formation of a second annular element, aimed at preventing the label 4 from being able to slide out.

It should be specified that the annular elements will be illustrated in detail with reference to FIGS. 5a to 5c.

The first bending device 22 can be made of a “fork” element, illustrated in FIG. 3c, which engages the end of the wire just cut and, by rotating on itself, forms the second annular element.

According to a possible embodiment, the first cutting device 22 consists of a folding winder driven in rotation by a Faulhaber brushless motor connected by means of a pair of gears, and a winder advancing/retreating device controlled by a pneumatic cylinder and provided with a grooved shaft such as to allow double movement (rotation-advancement). It is possible to provide a position sensor (backward) on the cylinder and a zero sensor of the winder rotation will be inserted).

At this point the wire has been processed so that one end is fixed to the strap 302, while the other end has been processed so as to block the label 4, while between the two ends there is a flat section, of variable length, equal to the distance between the strap 302 and the head of the bundle 300.

The wire thus formed is retained by the application head 2, which must release it in order to process the next wire portion and mark another bundle.

Retention means can thus be provided aimed at activating/deactivating at each processing of the wire.

According to the variant embodiment illustrated in FIGS. 3a-3c, such retention means can be integrated in the first 22 and in the second 26 bending device.

In this case, the fork element 22 and the castors 260, 261, 262 can be provided retractable, i.e., they can extend/compress along an axis perpendicular to the longitudinal axis of the application head 2, so as to allow the falling of the wire by gravity, in retracted condition.

Advantageously, to insert and remove the castors 260, 261, 262 from the working position, the entire bending device 26 is installed on a pneumatically actuated guide and provided with a forward and a rearward sensor.

Obviously, the gripping/releasing means 23 of the label 4 also allow the release of the processed wire, since the opening of the gripper constituting the means 23 contributes to allowing the drop of the wire with the label 4.

According to a possible embodiment, downstream of the winder, a guide channel connects to the label gripping/releasing means 23, consisting of a label pick-up gripper 4. This guide is supported by a gripper which allows the opening of the guide itself and the consequent release of the wire at the end of the cycle. The guide is provided with an open guide sensor.

The label gripper is operated by a pneumatic cylinder with an open gripper sensor and a closed gripper sensor. The jaws of the gripper are suitably shaped to allow the wire to be guided.

As anticipated, all components of the application head 2 are actuated by electronic or pneumatic mechanisms, which can be provided on board both the robotic arm 1 and the application head.

Lastly, it should be specified that the labelling system 100 of the present invention can include the following sensors:
LMI Gocator for 3D scanner analysis of the strap area and identification of the area and insertion position of the annular element,
Laser sensor for searching for the bundle (front position thereof)
Smart camera for reading the data matrix code of the label,
Colour sensor for verifying the presence of the label after insertion and release.

The above-described operation of the application head 2 is also included in the embodiment shown in FIGS. 4a and 4b, in which a positioning of the spool 3 on the application head 2 is envisaged and not at the “elbow” of the robotic arm.

As is clear from FIG. 4b, the components of the application head 2 are the same as those described relative to FIGS. 3a to 3b, unlike the positioning of the spool 3.

In accordance with FIGS. 4a and 4b, the spool 3 is fixed to the application head 2 with the unwinding axis positioned vertically, i.e., perpendicular with respect to the unwinding axis of the spool 3 of the previous figures.

FIGS. 5a to 5c illustrate some exemplary views to describe the operating method of the labelling system object of the present invention.

Preferably, before starting the marking cycle, the system object of the present invention includes executing general diagnostics.

In particular, for the correct development of the cycle, the following conditions must be present:
system in ready, i.e., ready to receive instructions,
compressed air pressure switch operating,
home robot sensor engaged,
robot activated without alarms,
printer ready, loaded with labels,
wire roll present,
wire inserted in the application head, up to at least the cutter 23,
wire-dragging motor operating,
winding rotation motor (first bending device 22) operating,
castor motor 260, 261, 262 operating,
winder 22 with pins removed (backward sensor not engaged),
winder in an upright position, so as to allow the wire to pass inside the fork element,
wire guide gripper closed (closed gripper sensor engaged),
label pick-up gripper open (open gripper sensor engaged),
castors in retracted position (backward castor sensor retracted),
movable castor in zero position (zero castor sensor engaged)
data sent to the printer.

Once all the diagnostics have been performed, the system can execute the marking procedure.

Preferably, the printer 200 prints and ejects the label 4 on the pick-up plane.

The label 4 is held in the correct position for the pick-up by means of the movement of the blocking hole

The label support box is advanced (backward sensor lost and then forward box sensor engaged).

The gripper of the gripping/releasing means 21 is open.

The robotic arm 1 is positioned in the label pick-up position so as to position the hole 41 of the label 4 in the appropriate position for the passage of the wire.

The gripper of the gripping/releasing means 21 is closed, so that the robotic arm 1 can extract the label 4 and position itself in standby for wire fixing.

FIG. 5a illustrates the step of fixing the wire to the strap 302: the application head 2 identifies the bundle 300, identifies the strap 302, calculates the distance between the head of the bundle 300 and the strap 302.

In particular, the robot 1 moves so as to detect the position of the head of the bundle 300 by means of a laser sensor and moves so as to scan the presumed zone of presence of the tie/band 302 by means of Gocator.

The robot positions the tool properly for the insertion of the wire in the band.

The application head 2 is positioned at the strap 302.

The castors 260, 261, 262 are brought to the wire-bending position. (The backward castor sensor is lost and then the forward castor sensor engaged).

The wire is advanced by activating the wire-dragging motor to pass through the label until it overcomes the movable castor.

The movable castor is rotated up to the defined position for bending (based on the desired ring diameter)

The wire is advanced, making an annular element 60 with multiple spirals, inserting under/around the strap 302.

At this point, FIG. 4b, the robot retracts in relation to the verified position of the front of the bundle 300 so as to position the label 4 outside the length/head of the bundle itself. During this movement, the wire dragger extends the wire in a coordinated manner with the movement of the robot.

The cutter of the cutting device 21 cuts the wire.

The robot moves to partially extract the wire from the guides

The winder of the bending device 22 is rotated 360°-720° so as to create the second annular element 61, provided at the end of the wire just cut, which retains the label 4.

At this point the wire is released, FIG. 4c, letting the label 4 fall, positioned outside the bundle 300.

In FIG. 4c, the second annular element 61 is provided inserted inside the hole 41 of the label 4, but, preferably, it is made outside the hole 41, so as to function as an abutment element which prevents the label 4 from being able to be removed.

A sensor can be provided aimed at verifying the actual presence of the label 4.

While the invention is subject to various modifications and alternative constructions, some preferred embodiments have been shown in the drawings and described in detail.

It should be understood, however, that there is no intention to limit the invention to the specific illustrated embodiment but, on the contrary, the aim is to cover all the modifications, alternative constructions and equivalents falling within the scope of the invention as defined in the claims.

The use of “for example”, “etc.” or “or” refers to non-exclusive non-limiting alternatives, unless otherwise stated.

The use of “includes” means “includes but is not limited to”, unless otherwise stated.

1. A labelling system of bundles of rods or bundles of bars, which bundles comprise one or more straps arranged around the bundle,
said system comprising a robotic arm, an application head of the label and at least one spool of metal wire, which robotic arm is configured for the movement of said application head,
means being present for activating the rotation of the spool, configured to convey the metal wire inside the application head,
characterized in that
the application head comprises wire processing means, automated object recognition means, and means for gripping/releasing at least one label,
the processing means being configured to unwind the wire and fix a first end of the wire to a strap of the bundle and to engage a second end of the wire to said label,
the automated object recognition means comprising identification means of the bundle configured to detect a first section, corresponding to the distance between a strap and an end of the bundle,
the wire processing means being configured to execute a cutting of the wire whereby the distance between the first end and the second end is greater than said first section.

2. The system according to claim 1, wherein said first and/or said second end of the wire consist of a bending of the wire so as to form a ring the ring of the first end being wound around the strap.

3. The system according to claim 1, wherein the processing means comprise an inlet wire guide element, a wire cutting device, a first wire bending device, said label gripping/releasing means, an outlet wire guide element and a second wire bending device.

4. The system according to claim 3, wherein said gripping/releasing means are configured to block the label so that the label has a hole in line with the inlet wire guide element.

5. The system according to claim 3, wherein a straightening device is present configured to straighten the wire, said straightening device being interposed between the inlet wire guide element and the outlet wire guide element.

6. The system according to claim 1, wherein a spool sensor is present aimed at detecting the quantity of wire present at the spool.

7. The system according to claim 1, wherein wire retention means are present inside the application head, which retention means pass from a wire retention condition to a wire release condition, in which the wire is free to exit from the application head.

8. The system according to claim 1, wherein the second bending device comprises at least three castors rotatably mounted and arranged on a plane so as to identify a space within which to pass the wire, at least one castor being mounted translatable along said plane.

9. The system according to claim 1, wherein said spool is positioned on the application head of the label.

10. A method for labelling bundles of rods or bundles of bars through the use of the system according to claim 1, comprising:
identifying the bundle,
identifying a band,
calculating the distance between the strap and one end of the bundle,
positioning the application head at the bundle,
unwinding the wire,
fixing a first end of the wire to the strap,
unwinding the wire,
cutting the wire so that the length between the two ends is greater than the distance between the band and the end of the bundle,
fixing the label to the second end,
releasing the cut wire from the application head.

11. The method according to claim 10, further comprising identifying a fixing seat of the first end of the wire is provided.
